(19) United States
(12) Patent Application Publication
(10) Pub. No.: US 2009/0006130 A1
(43) Pub. Date: Jan. 1, 2009

(54) SYSTEM, METHOD AND APPARATUS FOR COMPARING INJURY RISK ASSESSMENTS

(75) Inventors: Kevin James Taylor, Christchurch (NZ); Robert van Nobelen, Christchurch (NZ)

Correspondence Address: BLAKELY SOKOLOFF TAYLOR & ZAFMAN LLP, 1279 OAKMEAD PARKWAY, SUNNYVALE, CA, 94085-4040, US

(73) Assignee: Wellnomics Limited, Christchurch (NZ)

(21) Appl. No.: 12/147,452

(22) Filed: Jun. 26, 2008

Related U.S. Application Data
(60) Provisional application No. 60/946,600, filed on Jun. 27, 2007.

(51) Int. Cl. G06Q 50/00

(52) U.S. Cl. 705/2

(57) ABSTRACT

A method of calculating a relative indicator of injury risk for a group of individuals, where injury risk is assessed across at least one risk category associated with an injury risk factor, the method being characterised by the steps of; receiving a plurality of risk values, where a single risk value is received for each individual of the group for each risk category considered, calculating a risk ratio for each possible risk value available for each risk category considered using the received risk values, calculating a category metric for each risk category considered using the risk ratios of each risk category, and calculating a relative indicator of injury risk for the group using a linear combination of the calculated category metrics.

### CROSS-REFERENCE TO OTHER APPLICATIONS

This application claims priority from U.S. Provisional Patent Application No. 60/946,600, filed on Jun. 27, 2007, which is incorporated herein by reference in its entirety.

### TECHNICAL FIELD

This invention relates to a system, method and apparatus to be used to compare injury risk. In particular applications, the present invention may be employed to assess the relative risk of injury present between groups of computer users with a metric style measurement of overall injury risk.

### BACKGROUND ART

For some complaints it can be difficult to assess a person's risk of developing a certain injury where such complaints are caused over time by a number of risk factors working together. For example, stress related conditions or repetitive strain injuries have been identified as complaints which are associated with a wide number and range of variable risk factors.

The monitoring, prevention and treatment of work related muscular-skeletal disorders is an important issue to many organisations and employers. For example, repetitive strain injury disorders affect the health, well-being and productivity of a work force who employ computer input devices, such as mice or keyboards in the day to day performance of their duties.

The current state of the art in this field provides software based tools to facilitate injury prevention and rehabilitation. A good example of this type of existing tool is provided by the present applicant and is currently detailed at the internet domain www.workpace.com. This Workpace software product monitors a computer users input behaviour and can provide reminders with respect to the timing of breaks they should take and exercises to be completed to reduce their risk of injury. Warnings can also be provided to users if they exceed recommended typing speeds or work for too long without a break.

The first step involved with proactively addressing these issues is the recognition of computer users who are at risk of injury, or who may have a pre-existing condition aggravated by the use of computers. The assessment of injury risk in this field is difficult to complete accurately or quantifiably due to a significant number of variables at work which can contribute to such injuries.

Work station ergonomics, user fitness, posture and stress levels, typing speed and typing period durations, mouse speed and period durations, breaks or pauses taken by users and exercises completed by users all have an impact on risk of injury. Those working in this field will also appreciate that a large number of significant variables have an effect on a computer user's risk of injury, and the above list of factors should in no way be considered comprehensive.

The determination or assessment of injury risk is also a comparatively new and evolving field. Rigorous scientific examination of contributing risk factors and underlying risk factors has yet to be completed to an exhausted level for all relevant variables. Such research usually focuses on single risk factors and the importance or the weight that should be applied to their relevance in terms of overall risk to a computer user.

Furthermore, such pre-existing studies and conclusions with respect to risk factors may be superseded by new technology which is employed in novel ways by users. In particular the use of laptop computers requires a reassessment of the importance or weighting of particular risk factors when the specific location in which laptops are used is to be considered. Furthermore, the compressed configuration of the laptop keyboard and trackball mouse adds new variables to the mix of factors to be considered when injury risk is assessed.

Persons responsible for the health and well-being of staff in organisations need to know about the risk factors present for their computer users. Such managerial staff also need to be provided with feedback as to the effectiveness of any risk mitigation or prevention programs they have put in place, and any resulting reduction in injury risk provided by such programs. However, repetitive strain injuries are problematic due to the number of risk factors which need to be considered and the potential variation in the types, numbers and costs associated with different remedial actions which can be taken to reduce injury risk.

It would therefore be of advantage to have a system, method or apparatus which could provide a relative measurement of injury risk in association with a group of computer users, with this relative measurement giving an accurate indication of injury risk which can be compared to that of other groups. Such a relative measurement or metric of injury risk would be useful to managerial staff to allow groups of users to be benchmarked against other groups of their peers, either in the same industry or across different departments of the same business or organisation.

Furthermore, such a relative measurement could rapidly allow groups of users at significant risk relative to others to be targeted immediately with remedial risk mitigation measures or programs. A relative risk metric may also provide individual information with respect to specific risk factors at play for groups of computer users, and in turn give information as to how resources deployed within mitigation programs should be allocated for the most cost effective reduction in injury risk.

Such a metric could also provide management personnel with a concrete target to both improve on, and allow for the setting of goals or new targets to be achieved with risk mitigation programs.

All references, including any patents or patent applications cited in this specification are hereby incorporated by reference. No admission is made that any reference constitutes prior art. The discussion of the references states what their authors assert, and the applicants reserve the right to challenge the accuracy and pertinency of the cited documents. It will be clearly understood that, although a number of prior art publications are referred to herein, this reference does not constitute an admission that any of these documents form part of the common general knowledge in the art, in New Zealand or in any other country.

It is acknowledged that the term ‘comprise’ may, under varying jurisdictions, be attributed with either an exclusive or an inclusive meaning. For the purpose of this specification, and unless otherwise noted, the term ‘comprise’ shall have an inclusive meaning—i.e. that it will be taken to mean an inclusion of not only the listed components it directly references, but also other non-specified components or elements. This rationale will also be used when the term ‘comprised’ or ‘comprising’ is used in relation to one or more steps in a method or process.

It is an object of the present invention to address the foregoing problems or at least to provide the public with a useful choice.

Further aspects and advantages of the present invention will become apparent from the ensuing description which is given by way of example only.

### DISCLOSURE OF INVENTION

According to one aspect of the present invention there is provided a method of calculating a relative indicator of injury risk for a group of individuals, where injury risk is assessed across at least one risk category associated with an injury risk factor, the method being characterised by the steps of;
i) receiving a plurality of risk values, where a single risk value is received for each individual of the group for each risk category considered, and
ii) calculating a risk ratio for each possible risk value available for each risk category considered using the received risk values, and
iii) calculating a category metric for each risk category considered using the risk ratios of each risk category, and
iv) calculating a relative indicator of injury risk for the group using a linear combination of the calculated category metrics.

According to a further aspect of the present invention there is provided a method substantially as described above, wherein the indicator of injury risk is calculated from a sum of category metrics.

According to a further aspect of the present invention, there is provided a method substantially as described above, wherein the indicator of injury risk is calculated from a weighted sum of category metric values.

According to yet another aspect of the present invention there is provided a method substantially as described above, wherein a category metric calculation provides a boundary value when all individuals in the group exhibit a maximum or minimum risk value for the category.

According to yet another aspect of the present invention there is provided a method substantially as described above, wherein a risk value is represented by an unknown value.

The present invention is adapted to provide a method of calculating a relative indicator of injury risk for a group of individuals. Also within the scope of the present invention is an apparatus or system configured to implemented such a method, in addition to a set of computer executable instructions which when loaded on to a computer system provides such an apparatus or system. Reference in the main throughout this specification will however be made to the present invention being implemented via such a method, but those skilled in the art should appreciate that the present invention also extends to such physical apparatus and computer executable instructions.

The present invention can be employed to provide a relative indicator of injury risk for a group of individuals, preferably where these individuals employ computer input devices such as mice or keyboards. Reference in the main throughout this specification will also be made to the present invention being used to indicate injury risk associated with repetitive strain or occupational over-use syndrome injuries, such as those caused or aggravated by extended use of computer input devices. However, those skilled in the art should appreciate that other types of injuries may be assessed and also have their risk indicated with respect to a group of users in accordance with the present invention.

An indicator of injury risk may be provided in relation to any arbitrarily defined group or set of individuals. In general individuals may be grouped together in terms of a common relationship, such as completing a particular type of work, working for a specific employer or organisation, or working within a department of a particular organisation. The present invention may be used to calculate indicators of injury risk for any arbitrary selection of a group of individuals, where the indicator calculated can be used to provide a relative comparison against one or more additional groups of individuals.

For example, the present invention may be employed to calculate such indicators for particular departments of an organisation, or across the entire organisation on the whole. Such injury risk indicators can then be compared between departments to assess which department is in need of the most urgent attention in terms of risk mitigation programs, or can be used to provide a relative assessment as to where an organisation stands with respect to other similar organisations.

Preferably the risk of injury considered may be assessed across at least one, and preferably a range of risk categories, where each of these categories is associated with a particular risk factor known to contribute to or be a cause of injury. These risk factors may be identified through research, which over time could also identify additional risk factors to be taken in account in future. Preferably the present invention may facilitate the calculation of injury risk indicators which can in future also take into account additional or new risk factors which become apparent through future research.

For example, in the case of occupational over-use syndrome injuries, risk factors may include the categories of speed and intensity of work, posture and workstation ergonomics, levels of computer use and breaks, individual user factors, and/or workload and work environment. Those skilled in the art should appreciate that a wide number and range of risk factors and associated risk categories may be assessed by the present invention to calculate a relative injury risk indicator.

The present invention is initiated through the receipt of a plurality of risk values. One risk value may be received for each risk category considered from each individual within the group to have its injury risk indicated. Each risk value received will therefore reflect a particular individual's exposure to the risk factor associated with a specific risk category.

Preferably there may be a fixed number of discrete risk values associate with and able to be defined for each risk category. This discrete set of risk values may be organised or arranged in a hierarchy in terms of an individual's increasing exposure to the risk factor of the category.

Preferably an available risk value of a category may be an unknown value. Such an unknown value may be assigned to a particular category for an individual if no risk assessment data is available in relation to the individual for the risk factor. Preferably, such unknown values may be arranged in a hierarchy of risk values so as to have a neutral or minimal effect on the overall resulting indicator calculated in conjunction with the present invention.

In a preferred embodiment four risk values may be available for assignment to a particular risk category, being high risk, medium risk, an unknown risk value and low risk. Furthermore, this ordering of risk values may set a hierarchy of risk exposure from high, medium, unknown and low risk values substantially as described above.

Once a full set of risk values are available for the group a set of risk ratios may be calculated for each possible risk value available for each risk category. Preferably the risk ratio for a specific risk value for a specific risk category is the proportion of the group of individuals which exhibit the risk value in the risk category. Therefore if, for example, four discreet risk values are available for assignment to a particular category, four risk ratios can be made available or calculated for this category.

The received risk values from the group of individuals can be employed to populate the risk values of a category, and to subsequently provide a size value for the group. This information can be used to calculate a relative risk ratio for each discrete risk value available.

The risk ratios obtained for a particular risk category are employed to calculate a category metric. A category metric calculation may define one of a set of component sub functions employed to provide the indicator required of the present invention. A category metric value may give a relative indicator of the groups' exposure to a particular risk factor in isolation—as opposed to a general indication of injury risk on the whole based on a number of contributing risk factors. Such category metrics may, for example, also be considered in isolation when trying to diagnose why a particular group of individuals has an overall high injury risk indicator when compared with relevant groups of their peers.

Preferably the calculation or function defined to provide a category metric for a risk category produces a boundary value when all individuals within the group exhibit the maximum or minimum level risk value for the risk category. For example, when all members of the group exhibit the highest or lowest risk factor the category metric value calculated will be a maximum or a minimum boundary value.

In a preferred embodiment a category metric value (M) may be calculated using the following expression or formula;

M=(W₁×F₂(R₂)×F₃(R₃)× . . . ×F_{J}(R_{J}))+W₂R₂+W₃R₃+ . . . +W_{J}R_{J}

where;
J=the number of discrete risk values available for the category
R₁, R₂, R₃ . . . R_{J}=the risk ratios of the category
W₁, W₂, W₃ . . . W_{J}=a set of constants with J members,
Fⱼ (Rⱼ)=aⱼ exp(−CⱼRⱼ)+bⱼ, j>1
bⱼ=1−aⱼ

$${a}_{j} = \frac{1}{1 - exp ( - {C}_{j} )}$$

C₂, C₃ . . . C_{J}=a set of constants with J−1 members.

This metric calculation formula results in a metric value (M) which has an exponential drop off in every direction from a boundary value associated with the constant W₁. The constant W₁ is representative of a special case where all individuals possess the lowest possible risk value for the category. The remaining constants W₂ . . . W_{J} also represent other special cases or points where all individuals in the group again possess or exhibit the same risk value for the category. This metric calculation also reflects the real world effort required to produce reductions in risk exposure of groups of users already at low risk—as opposed to groups of users originally at a higher risk level. The constant values C₂, C₃ . . . C_{J} represent the decay rate of the metric value towards risk levels other than low risk.

To select specific values for the constants used, the specific risk level values within the system need to be set. For example, a system can be provided with the following four risk levels:

| j | Risk Level |
|---|---|
| 1 | Low |
| 2 | Medium |
| 3 | High |
| 4 | Unknown |

Corresponding to these risk levels are the values W₁, W₂, W₃, and W₄ that are representative of special cases, and may be set so that the category risk metric has the following extreme or boundary values:

| j | Description | Parameter | Value |
|---|---|---|---|
| 1 | All Users Low Risk | W₁ | 10 |
| 2 | All Users Medium Risk | W₂ | −5 |
| 3 | All Users High Risk | W₃ | −10 |
| 4 | All Users Unknown Risk | W₄ | 0 |

These values determine boundary points of the metric and set the W parameters. To determine the exponential decay parameters Cⱼ a selection of specific metric values at specific points can be made, e.g

M(1−Z₂,Z₂,0, . . . , 0)=V₂;

M(1−Z₃,0,Z₃, . . . , 0)=V₃;

M(1−Z_{J},0,0, . . . , Z_{J})=V_{J},

where Zᵢ are risk ratios along a specific axis where the metric is specified to have a value Vᵢ. In the situation outlined below, for example, the situation where half the group have medium risk (Z₂=0.5) the value of the metric (V₂) is chosen to be zero. In this way a user can design a wide range of metrics that recognize the relative importance between risk levels.

Note: The equations only have a solution if Wⱼ<Vⱼ. Substituting and rearranging these equations gives:

(exp(−CⱼZⱼ)−exp(−Cⱼ))/(1−exp(−Cⱼ))=(VᵢWⱼZⱼ)/W₁

which can be solved numerically to determine Cⱼ. The following table shows values of Cⱼ for the corresponding chosen values of Zⱼ and Vⱼ.

| j | Description | Zᵢ | Vᵢ | Cᵢ |
|---|---|---|---|---|
| 1 | Low | — | — | — |
| 2 | Medium | 0.5 | 0 | 2.20 |
| 3 | High | 0.2 | 0 | 8.04 |
| 4 | Unknown | 0.5 | 2 | 2.77 |

However, those skilled in the art should appreciate other types of functions or calculations may be employed to provide category metric values as an alternative to that discussed above. Any appropriate function employing input risk ratio parameters which may also exhibit a boundary value at appropriate points of the function may alternatively be used in conjunction with the present invention.

Preferably once category metrics are available for each risk category to be considered, a relative indicator of injury risk may be calculated for the group involved. This indicator can be composed from a linear combination of the category metrics, being in practice a collection of component sub-functions employed to provide the indicator.

In a preferred embodiment the resulting numeric values of each category metric may be summed together to provide a numeric indicator of injury risk for the group. In a further preferred embodiment a weighting may be applied to each category metric value prior to a sum being completed to provide the indicator. Weighting of category metrics allows the relative importance or effect of each risk factor associated with a category to be taken into account when an overall risk indicator is calculated. If a particular risk category is dominant over other categories in its effect on injury risk, a more dominant weighting factor can be applied to this category metric with respect to the other category metrics.

Such a weighted sum of category metrics can provide a linear combination of category metric values which represent the effect of a range of risk factors on the risk of injury of a group of users. Furthermore, this linear combination (or preferably a weighted sum) also allows new risk factors and associated risk categories to be considered in future if found to be pertinent.

The present invention may provide many potential advantages over the prior art.

The present invention allows for a comparative indication of injury risk to be prepared for a group of individuals. This indicator or overall metric value can be used to provide a comparative assessment of the current state of the group's risk of injury when compared with that of their peers in different departments of an organization, or other related organizations within the same field or industry.

The present invention may also provide a tangible numeric target for future improvements in injury risk reduction and give a quantitative indicator of how well such risk reduction programs have performed.

The present invention may allow for the rapid identification of particular groups or sub-groups of users who are in urgent need of risk mitigation programs, and potentially may also assist in the selection of the type of risk mitigation action which should be taken in relation to such groups.

The use of risk ratios allows for comparative injury risk indicators to be prepared—irrespective of the size of the groups of individuals involved. The formulation of injury risk indicators from linear combinations of risk category sub-functions also allows new sub-functions to be added to the calculation of the indicator if new risk factors are discovered in future. Furthermore, the combination of such risk factor focused categories may also be variably weighted in preferred embodiments relative to one another depending on the relative effect of a particular risk factor with respect to others.

The calculation of individual category metrics can also take into effect the absence of data in relation to an individual's exposure to a particular risk factor. Through the use of an unknown value as a risk value the absence of use of an individual's assessment data can be arranged to have a minimal or neutral effect on the category metric and overall indicator calculated.

### BRIEF DESCRIPTION OF DRAWINGS

Further aspects of the present invention will become apparent from the following description which is given by way of example only and with reference to the accompanying drawings in which:

FIG. 1 illustrates a schematic flowchart of a process executed to prepare an overall indicator of injury risk for a group of individuals in one embodiment, and

FIG. 2 shows a block schematic diagram of components employed to provide an apparatus used to implement the methodology illustrated with respect to FIG. 1.

### BEST MODES FOR CARRYING OUT THE INVENTION

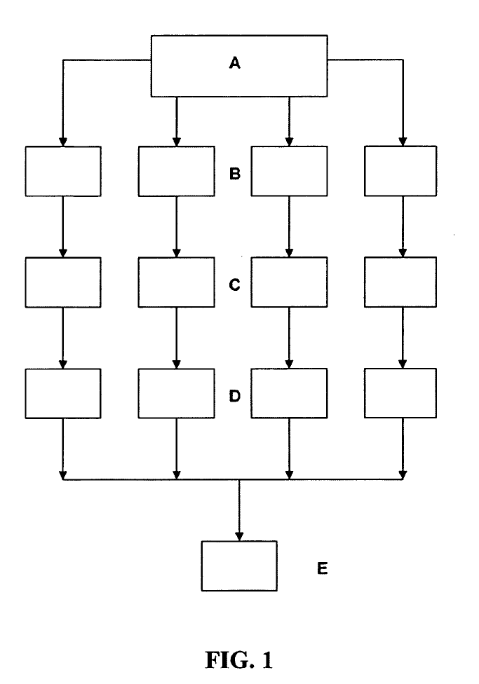

FIG. 1 illustrates a schematic flowchart of a process executed to prepare an overall indicator of injury risk for a group of individuals in one embodiment.

The first stage of this process (A) is executed when a risk measurement system initially gathers risk assessment data from all individuals making up a group which is to have its injury risk indicated. This collection of assessment data spans a number of risk categories associated with particular injury risk factors and is composed of a range of risk values across this set of risk categories.

At stage (B) of this process the assessment data collected is divided into sets of risk values associated with a particular risk category. In the embodiment illustrated four risk categories are considered in conjunction with the present invention.

At stage (C) of this process the risk values collated for each category are in turn used to calculate a set of risk ratios for each category. These risk ratios indicate the proportion of the group of individuals which possess a specific discrete risk value available for the category. If, for example, four discrete risk values are available for assignment to a category, four risk ratios are calculated at stage (C).

At stage (D) of this process four separate risk metrics are calculated, being one risk metric for each risk category under consideration. These category metrics are constructed so as to exhibit a boundary maximum or minimum value when all members of the group of individuals exhibit a maximum or minimum risk value.

Lastly at stage (E) of this process each of the category metrics are combined together as a range of sub-functions to provide a final overall indicator of injury risk for the group. Preferably a linear combination of these category metrics is provided through a weighted sum of category metric values.

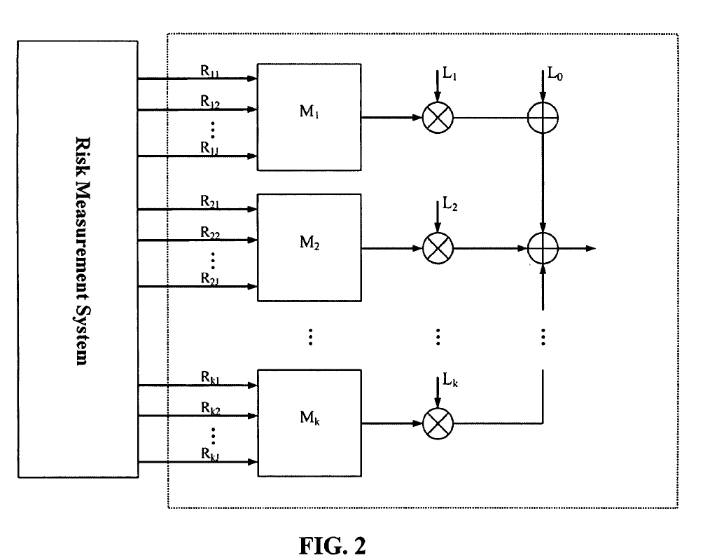

FIG. 2 shows a block schematic diagram of components employed to provide an apparatus used to implement the methodology illustrated with respect to FIG. 1.

As illustrated with respect to FIG. 2 a risk measurement system is employed to collect and collate a set of risk values, and to also provide a set of risk ratios in relation to each risk category to be considered. The risk ratios supplied, (R₁₁) through to (R_{KJ}), indicate that K number of categories are considered, where each category has J number of possible risk values which can be assigned to it by a users risk assessment data.

Each of the received risk ratios are collated and supplied to a metric calculation system which produces a category metric value M₁, M₂ . . . M_{K} for each category under consideration.

Next each category metric value is multiplied by a weighting factor L₁, L₂, . . . L_{K} and subsequently summed together with an additional weighting value L₀ to provide a final output overall injury risk indicator.

Aspects of the present invention have been described by way of example only and it should be appreciated that modifications and additions may be made thereto without departing from the scope thereof as defined in the appended claims.

What is claimed:

1. A method of calculating a relative indicator of injury risk for a group of individuals, where injury risk is assessed across at least one risk category associated with an injury risk factor, the method being characterised by the steps of;
i) receiving a plurality of risk values, where a single risk value is received for each individual of the group for each risk category considered, and
ii) calculating a risk ratio for each possible risk value available for each risk category considered using the received risk values, and
iii) calculating a category metric for each risk category considered using the risk ratios of each risk category, and
iv) calculating a relative indicator of injury risk for the group using a linear combination of the calculated category metrics.

2. A method of calculating a relative indicator of injury risk for a group of individuals as claimed in claim 1 wherein a risk value is represented by an unknown value.

3. A method of calculating a relative indicator of injury risk for a group of individuals as claimed in claim 1 wherein four risk values are available for assignment to a particular risk category, being high risk, medium risk, an unknown risk value and low risk.

4. A method of calculating a relative indicator of injury risk for a group of individuals as claimed in claim 1 wherein the risk ratio for a specific risk value for a specific risk category is the proportion of the group of individuals which exhibit the risk value in the risk category.

5. A method of calculating a relative indicator of injury risk for a group of individuals as claimed in claim 1 wherein the linear combination is a sum of category metrics.

6. A method of calculating a relative indicator of injury risk for a group of individuals as claimed in claim 1 wherein the linear combination is a weighted sum of category metric values.

7. A method of calculating a relative indicator of injury risk for a group of individuals as claimed in claim 1 wherein a category metric calculation provides a boundary value when all individuals in the group exhibit a maximum or minimum risk value for the category.

8. A computer readable medium having stored thereon instructions that are executable by a processor of a computer to implement a method of calculating a relative indicator of injury risk for a group of individuals as claimed in claim 1 wherein a category metric value (M) is calculated using the following algorithm;
M=(W₁×F₂(R₂)×F₃(R₃)× . . . ×F_{J}(R_{J}))+W₂R₂+W₃R₃+ . . . +W_{J}R_{J}
where;
J=the number of discrete risk values available for the category
R₁, R₂, R₃ . . . R_{J}=the risk ratios of the category
W₁, W₂, W₃ . . . W_{J}=a set of constants with J members,
Fⱼ (Rⱼ)=aⱼ exp(−CⱼRⱼ)+bⱼ, j>1
bⱼ=1−aⱼ
$${a}_{j} = \frac{1}{1 - exp ( - {C}_{j} )} , and$$
C₂, C₃ . . . C_{J}=a set of constants with J−1 members.
